(19) United States
(12) Patent Application Publication
(10) Pub. No.: US 2014/0280863 A1
(43) Pub. Date: Sep. 18, 2014

(54) Consumer Device Intelligent Connect

(71) Applicant: Kadari Subbarao Sudeendra Thirtha Koushik, Bangalore (IN)

(72) Inventor: Kadari Subbarao Sudeendra Thirtha Koushik, Bangalore (IN)

(21) Appl. No.: 13/801,272

(22) Filed: Mar. 13, 2013

(51) Int. Cl. H04L 12/26

(52) U.S. Cl. CPC H04L 43/00
USPC 709/224

(57) ABSTRACT

A method and system provides a Consumer Device Intelligent Connect (CDIC) to create awareness of presence of multiple devices with the user under-one-roof or on-the-move is disclosed. The method disclosed enables the user to pre-register the devices on a user database of a CDIC server. The CDIC server identifies active devices in the communication network along with their geographical locations, from the list of pre-registered devices. The CDIC server then intelligently processes the stored information and provides this information to the media server. The information provided by CDIC server enables media servers to develop user interactivity, deploy monetization services such as advertizing, user feedback and so on using the ubiquitous multiple devices of the user.

The present application is based on, and claims priority from, IN Application Number 4673/CHE/2012, filed on 7 Nov. 2012, the disclosure of which is hereby incorporated by reference herein.

### TECHNICAL FIELD

The embodiments herein relate to connecting various user devices and more particularly to using an intelligent connect system to connect various devices either under one roof or geographically spread out.

### BACKGROUND

Trends in mobile communications have brought up a new breed of portable intelligent communication devices such as palmtops, Personal Digital Assistant (PDA), tablets and smart phones and so on. Today's user owns multiple devices that provide the user with plurality of communication resources, eventually enabling better user connectivity. Moreover, simultaneous use of such multiple devices by the user is quite common scenario. For example, when a user watches a television (TV) program his/her mobile phone, tablet is also used to various degrees. This can be under-one-roof where multiple devices used by user are geographically co-located and connected to each other through a local communication network. In other case, when the user is on-the-move, the devices of the user may be geographically separated without any interconnection among these devices. Tapping user needs and effectively reaching the user for monetizing is critical in today's competitive market. In such a scenario, intelligent way of knowing multiple devices enables to reach the user effectively and is critical to create a positive impact of having multiple devices simultaneously.

With existing methods an awareness of presence of multiple devices in ‘under-one-roof’ scenario or ‘on-the-move’ scenario is absent or partial. The creation of intelligence based on the above awareness is also absent or partial. The existing methods fail to provide real time updates of such information to the broadcasters, content providers and Multiple System Operators (MSO) and so on. Thus, design and delivery, monetization of opportunities using intelligence platform is missing or minimal.

In light of above discussion, a system for providing intelligence that enables multiple devices of the user to be aware of each other to develop interactivity and monetization services along with enhanced user experience is appreciated.

### BRIEF DESCRIPTION OF THE FIGURES

The embodiments herein will be better understood from the following detailed description with reference to the drawings, in which:

FIG. 1 illustrates exemplary block diagram of a Consumer Device Intelligent Connect (CDIC) system, according to the embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system that provides a Consumer Device Intelligent Connect (CDIC) to create awareness of presence of multiple devices with the user under-one-roof or on-the-move. The method enables the user to pre-register the devices on a user database of a CDIC server. The method identifies active devices in the communication network along with their geographical locations, from the list of pre-registered devices. The method stores this data along with other information such as user profile, user preferences in user database of the CDIC server. The CDIC server processes the stored information and thereafter provides this information to the content providers, broadcasters, Multiple System Operators (MSO) and so on. The information provided by CDIC server enables media servers of the content providers, the broadcasters, the MSO and so on to develop user interactivity, deploy monetization services such as advertizing, user feedback and so on using the ubiquitous multiple devices of the user. The CDIC system enables media servers to provide user friendly, intuitive and value added services. The CDIC system enhances user experience by displaying content on interactive devices.

The active device is a pre-registered user device currently connected to the external central CDIC and media servers.

Throughout the description the term active device and online device are used interchangeably.

Under-one-roof refers to plurality of active user devices that are geographically co-located and connected to each other through local communication network and connected to the central CDIC server and the media servers through the external communication network.

On-the-move refers to plurality of user devices that are geographically separated. Some devices may be under-one-roof while some devices may be out of range of the local communication network. The active devices are connected to the central CDIC server and the media servers independently through external communication network.

In an embodiment, the local communication network can be Wireless Fidelity (Wi-Fi) Direct, Wi-Fi, Local Area Network (LAN) and the like.

In an embodiment, the external communication network can be Global Packer Radio Switching (GPRS), 3G, 4G and the like.

In an embodiment, the device can be a mobile telephone, a cellular phone, a personal communications system (PCS) terminal, radiotelephone with data processing, an electronic notepad, a laptop, a personal computer, a tablet, a personal digital assistant (PDA), a gaming device or console, a peripheral (e.g., wireless headphone), a digital camera, a media player, a television and the like.

FIG. 1 illustrates exemplary block diagram of a CDIC system, according to the embodiments disclosed herein. The FIGURE depicts a CDIC server 100, a media server 101, a user database 102, a device 103a, a device 103b, a device 103c and a device 103d. The devices 103a, 103b, 103c and 103d belong to a single user and connected in the same local communication network (P2P). These devices are pre-registered with the CDIC server 100. The CDIC server 100 collects the information (context flow) of the pre-registered user devices based on user authentication such as user-id, password and so on. The CDIC server 100 stores the user information as well as device information on the user database 102.

In an embodiment, an application can be installed in the devices 103a, 103b, 103c, 103d which enables user to log on to the CDIC server 100.

In an embodiment, the device information comprises device details such as device ID, IMEI number, model number, device location, device Operating System (OS) and so on.

In an embodiment, the user information comprises user preferences, user profiles and so on.

The CDIC server 100 updates the user analytics on usage pattern, location, timing and so on. The CDIC server 100 creates map of active devices in the communication network. Thereafter, the CDIC server 100 uses either a look-up table or user database 102 to extract user preferences; user profiles and intelligently combines the information and sends to media server 101. The media server 101 then delivers user specific content (precise content flow that includes audio and/or video content) to the active devices based on services it offers to the user. For example, services offered to the user can be creating interactivity such as user feedback on content delivered or obtaining voting on programs broadcasted and so on. The interactivity provided by CDIC system enables content providers to create feedback polls, audits, surveys.

For example, a user watches a reality show on the television in the living room, along with his/her other active (on-line) devices such as tablet, smart phone. The CDIC server 100 collects this information of active user devices and provides it to the media server 101. The media server 101 typically broadcasts a message requesting SMS voting in favor of the participants of the reality show to the television sets. In such scenario, television being a non-interactive device user uses mobile phone to send the SMS. The method disclosed enables the CDIC server 100 to provide the broadcaster's media server 101 with information regarding multiple active devices with the user. The broadcaster may prefer transmitting same voting details on the user's active tablet. The user then can quickly and interactively respond to the voting request. The CDIC system enables the user to interact without spending charges over sending the SMS using cellular network. The CDIC is also aware of information of the operating systems of the active devices and enables media server 101 to transmit the contents accordingly. Thus, CDIC provides enhanced user experience.

In case user leaves the living room and is on-the-move, the device information with the CDIC sever is updated in real time. The CDIC server uses the Global Positioning System (GPS) on the tablet to extract co-ordinates of the device. The information of the co-ordinates along with user preferences in the user database 102 enables CDIC server 100 to logically group the tablet to the living room devices. The media server 101 can use this information to decide on the content to be transmitted to the tablet device.

Since, Television not being a user interactive device is not sought after by users today. Advertisements broadcasted on television unnecessary add to increased cost, time and effort for an advertiser. The CDIC system, with its awareness of active devices with the user, provides enhanced accuracy for target advertizing. For example, with knowledge of various active devices with the user, their locations and their operating systems, a cold drink company advertizes its cold drink bottle onto the mobile phone of the user by transmitting only a snap of the bottle and transmits a short video clip of the cold drink to advertize on user's tablet while broadcasts a full-fledged advertisement on the television. Thus, the CDIC system enables the cold drink company to reach a possible customer in all possible ways, irrespective of the geographical location of user. The CDIC system thus provides enhanced accuracy in target advertizing.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a CDIC system to connect various user devices either under one roof or geographically spread out. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiments may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method to connect various user devices, wherein said method comprises:
registering user devices with a Consumer Device Intelligent Connect (CDIC) server connected in a network;
identifying online status of said user devices in said network by said CDIC server;
creating a logical map of said identified user devices by said CDIC server;
sending information of said identified user devices to a media server by said CDIC server;
providing content to said user devices by said media server.

2. The method as in claim 1, wherein said method further comprises updating information of said user devices by said CDIC server after creating said logical map.

3. The method as in claim 1, wherein said user devices are registered in a user database of said CDIC server.

4. The method as in claim 1, wherein logical map comprises detecting geographical location of said online devices based on Global Positioning System (GPS) co-ordinates.

5. The method as in claim 2, wherein said information of said user devices is updated by tracking at least one of: said online status, GPS co-ordinates of said user devices.

6. A system to connect various user devices, wherein said system comprises a Consumer Device Intelligent Connect (CDIC) server, user devices, media server, user database, further said system is configured to:
register said user devices with said CDIC server connected in a network;
identify online status of said user devices in said network by said CDIC server;
create a logical map of said identified user devices by said CDIC server;
send information of said identified user devices to said media server by said CDIC server; and
providing content to said user devices by said media server.

7. The system as in claim 6, wherein said system is configured to connect various user devices irrespective of the geographic location of said user devices.

8. A Consumer Device Intelligent Connect (CDIC) server to connect various user devices in a network, wherein said CDIC server comprises:
an integrated circuit further comprising at least one processor;
at least one memory having a computer program code within said circuit;
said at least one memory and said computer program code configured with said at least one processor cause said CDIC server to:
register user devices;
identify online status of said user devices;
create a logical map of said identified user devices; and
update information of said user devices to a media server.
